(19) United States
(12) Patent Application Publication
(10) Pub. No.: US 2024/0047685 A1
(43) Pub. Date: Feb. 8, 2024

(54) ALL SOLID STATE BATTERY OPERABLE AT ROOM TEMPERATURE AND METHOD OF MANUFACTURING SAME

(71) Applicants: Hyundai Motor Company, Seoul (KR); Kia Corporation, Seoul (KR)

(72) Inventors: Sang Wan Kim, Anyang, Gyeonggi-do (KR); Hong Suk Choi, Hwaseong, Gyeonggi-do (KR); Hee Soo Kang, Seoul (KR); Jae Min Lim, Suwon, Gyeonggi-do (KR); Seon Hwa Kim, Cheongju, Chungcheongbuk-do (KR)

(73) Assignees: Hyundai Motor Company, Seoul (KR); Kia Corporation, Seoul (KR)

(21) Appl. No.: 18/124,704

(22) Filed: Mar. 22, 2023

(30) Foreign Application Priority Data
Aug. 5, 2022 (KR) 10-2022-0097662

(51) Int. Cl. H01M 4/62; H01M 4/04; H01M 10/0562

(52) U.S. Cl. CPC H01M 4/625; H01M 4/0404; H01M 4/0407; H01M 4/0471; H01M 10/0562; H01M 2004/021

(57) ABSTRACT

Proposed are an all-solid-state battery operable at room temperature and a method of manufacturing the same. The all-solid-state battery includes a negative electrode current collector, an intermediate layer positioned on the negative electrode current collector and including a carbon material and a metal capable of forming an alloy with lithium, a solid electrolyte layer positioned on the intermediate layer, a positive electrode layer positioned on the solid electrolyte layer, and a positive electrode current collector positioned on the positive electrode layer. The positive electrode layer includes a sheet layer with a network structure in which carbon nanotubes are arranged to provide pores and a positive electrode material filling the pores.

### CROSS REFERENCE TO RELATED APPLICATION

The present application claims priority to Korean Patent Application No. 10-2022-0097662, filed Aug. 5, 2022, the entire contents of which is incorporated herein for all purposes by this reference.

### TECHNICAL FIELD

The present disclosure relates to an all-solid-state battery operable at room temperature and a method of manufacturing the same.

### BACKGROUND

An all-solid-state battery is a three-layer laminate including positive electrode active material layer bonded to a positive electrode current collector, a negative electrode active material layer bonded to a negative electrode current collector, and a solid electrolyte layer disposed between the positive electrode active material layer and the negative electrode active material layer.

Typically, the negative electrode active material layer includes a solid electrolyte allowing migration of lithium ions as well as negative active materials such as graphite therethrough. Generally, solid electrolytes have a greater specific gravity than liquid electrolytes. For this reason, all-solid-state batteries using a solid electrolyte have a less energy density than lithium-ion batteries using a liquid electrolyte.

To overcome such a problem and increase the energy density of all-solid-state batteries, research on the use of lithium metal as a negative electrode is in progress. However, for commercialization of all-solid-state batteries, there are still many obstacles to be overcome, including technological issues such as interfacial bonding and growth of lithium dendrites and industrial issues such as price and large-scale optimization.

Recently, research has been conducted on a storage-type anode-less all-solid-state battery that has no anode so that lithium ions (Li⁺) are directly deposited on an anode current collector.

### SUMMARY

In preferred aspect, provided are an all-solid-state battery operable at room temperature and a method of manufacturing the same.

A term “all-solid-state battery” as used herein refers to a rechargeable secondary battery that includes an electrolyte in a solid state. In certain embodiments, the all-solid state battery may be an anodeless all-solid-state battery.

A term “anode-free all-solid-state battery,” “anodeless all-solid-state battery,” “anode-free battery,” or “anodeless battery” as used herein refers to an all-solid-state battery including a bare current collector at its anode side, which is in contrast to a battery that uses lithium metal as an anode. The anode-free all-solid-state battery may include a coating layer on a current collector including materials that induce conduction of lithium ions to a surface of the current collector.

Objectives of the present disclosure are not limited to the objectives mentioned above. The above and other objectives of the present disclosure will become more apparent from the following description, and will be realized by the means of the appended claims, and combinations thereof.

In an aspect, provided is an all-solid-state battery including a negative electrode current collector, an intermediate layer positioned on the negative electrode current collector and including a carbon material and a metal capable of forming an alloy with lithium, a solid electrolyte layer positioned on the intermediate layer, a positive electrode layer positioned on the solid electrolyte layer, a positive electrode current collector positioned on the positive electrode layer. The positive electrode layer may include a sheet layer having a network structure and including carbon nanotubes that are arranged to provide pores. In particular, a positive electrode material may fill or impregnate the pores.

A term “sheet” or “sheet layer” as used herein refers to a three-dimensional shape of a sheet, film or a thin layer, which has a planar surface and a substantially reduced thickness (e.g., millimeter, micrometer, or nanometer scale) compared to a width or a length of the planar surface. In certain aspects, the sheet layer may have a microscale thickness, e.g., thickness less than about 990 μm, less than about 900, lam, less than about 800 μm, less than about 700 μm, less than about 600 μm, less than about 500 μm, less than about 400 μm, less than about 300 μm, less than about 200 μm, or less than about 100 μm.

The sheet layer may include an oxygen-containing functional group on a surface thereof.

The oxygen-containing functional group may include one or more selected from the group consisting of a ketone group (—C═O), a carboxyl group (—COOH), and a hydroxyl group (—OH).

The sheet layer may have a porosity in a range of about 60% to 80%.

The sheet layer may have a specific surface area in a range of about 200 m²/g to 1,000 m²/g.

The sheet layer may have a thickness in a range of about 10 μm to 200 μm.

The positive electrode material may include a positive electrode active material and a solid electrolyte.

The positive electrode layer may include about 0.5% to 5% by weight of the sheet layer, about 75% to 90% by weight of the positive electrode active material, and about 5% to 20% by weight of the solid electrolyte, based on the total weight of the positive electrode layer.

The carbon material may include amorphous carbon, and the metal may include one or more selected from the group consisting of gold (Au), platinum (Pt), palladium (Pd), silicon (Si), silver (Ag), aluminum (Al), bismuth (Bi), tin (Sn), and zinc (Zn).

The all-solid-state battery may be operable in a temperature range of about 15° C. to 25° C.

In an aspect, provided is a method of manufacturing an all-solid-state battery. The method includes preparing a thin film having a network structure and including carbon nanotubes that are arranged to provide pores, preparing a sheet layer by performing acid treatment, heat treatment, or combinations thereof on the thin film, preparing a positive electrode layer by filling the pores of the sheet layer with a positive electrode material, and preparing an all-solid-state battery including a laminate formed by stacking a negative electrode current collector, an intermediate layer including a carbon material and a metal capable of forming an alloy with lithium, a solid electrolyte layer, the positive electrode layer, and a positive electrode current collector.

The acid treatment may be performed by immersing the thin film in an acid solution.

The heat treatment may be performed by heating the thin film to a temperature range of about 300° C. to 500° C. for a period in a range of about 10 minutes to 2 hours in an atmospheric atmosphere.

The positive electrode material may fill the pores of the sheet layer by applying of a slurry including the positive electrode material on the sheet layer.

In an aspect, provided are an all-solid-state battery operable at room temperature and a manufacturing method thereof.

Further provided is a vehicle including the all-solid-state battery as described herein.

Other aspects of the invention are disclosed infra.

### BRIEF DESCRIPTION OF THE DRAWINGS

FIG. 1 shows an exemplary all-solid-state battery according to an exemplary embodiment of the present disclosure;

FIG. 2 shows a charged state of an exemplary all-solid-state battery according to an exemplary embodiment of the present disclosure;

FIG. 3 shows an exemplary positive electrode layer according to an exemplary embodiment of the present disclosure;

FIG. 4 shows a scanning electron microscope (SEM) analysis result for a sheet layer prepared according to Preparation Example;

FIG. 5 shows an SEM analysis result for a cross-section of a positive electrode layer prepared according to Comparative Example, the analysis being performed when an all-solid-state battery is in a discharged state;

FIG. 6 shows the capacity of all-solid-state batteries of Example and Comparative Example; and

FIG. 7 shows the capacity retention rate of all-solid-state batteries of Example and Comparative Example.

### DETAILED DESCRIPTION

Above objectives, other objectives, features, and advantages of the present disclosure will be readily understood from the following preferred embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art.

Throughout the drawings, like elements are denoted by like reference numerals. In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component.

The singular expression includes the plural expression unless the context clearly indicates otherwise. It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween. Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Further, unless specifically stated or obvious from context, as used herein, the term “about” is understood as within a range of normal tolerance to in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

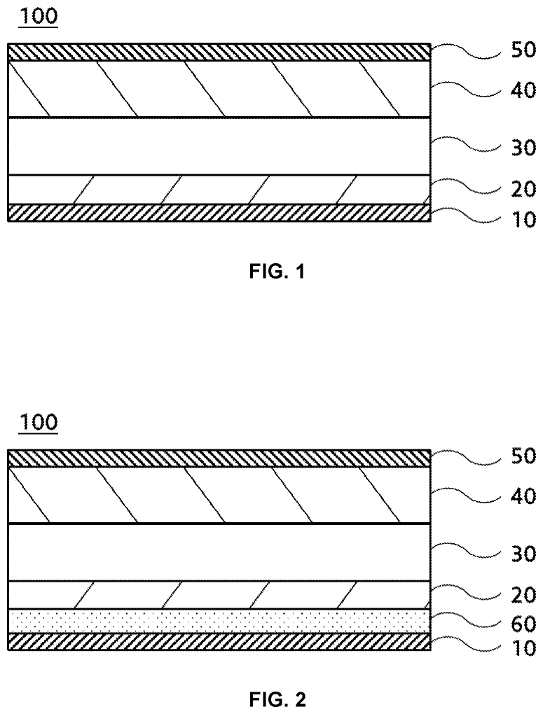

FIG. 1 shows an exemplary all-solid-state battery according to an embodiment of the present disclosure. The all-solid-state battery 100 may be a battery in which a negative electrode current collector an intermediate layer 20, a solid electrolyte layer 30, a positive electrode layer 40, and a positive electrode current collector 50 are sequentially laminated.

The negative electrode current collector 10 may be an electrically conductive plate-shaped substrate. The negative electrode current collector 10 may have a form of a sheet, a thin film, or a foil.

The negative electrode current collector 10 may include a material that does not react with lithium. For example, the negative electrode current collector 10 may include Ni, Cu, stainless steel (SUS), or combinations thereof.

Thickness of the negative electrode current collector 10 is not particularly limited. For example, the negative electrode current collector 10 may have a thickness in a range of about 1 μm to 500 μm.

The intermediate layer 20 may include a carbon material and a metal capable of forming an alloy with lithium.

The carbon material may include amorphous carbon. The amorphous carbon is not particularly limited. For example, the amorphous carbon may include furnace black, acetylene black, Ketjen black, and the like.

The metal may include one or more selected from the group consisting of gold (Au), platinum (Pt), palladium (Pd), silicon (Si), silver (Ag), aluminum (Al), bismuth (Bi), tin (Sn), and zinc (Zn).

An amount of each component of the intermediate layer 20 is not particularly limited, and may be appropriately adjusted for a desired effect. For example, the intermediate layer 20 may include an amount of about 50% to 99% by weight of the carbon material and an amount of about 1% to 50% by weight of the metal based on the total weight of the intermediate layer.

FIG. 2 shows a charged state of an exemplary all-solid-state battery 100. The all-solid-state battery 100 may include a lithium layer 60 formed between the negative electrode current collector 10 and the intermediate layer 20 in a charged state. Lithium ions released from the positive electrode layer 40 at the early stage of charging of the all-solid-state battery move to the intermediate layer 20 through the solid electrolyte layer 30. The lithium ions react with the metal of the intermediate layer 20 to form a lithium alloy between the negative electrode current collector 10 and the intermediate layer 20. When the all-solid-state battery 100 is continuously charged, lithium is uniformly deposited or precipitated around the lithium alloy to form the lithium layer 60. Lithium metal may be included in the lithium layer 60.

The solid electrolyte layer 30 is positioned between the positive electrode layer 40 and the negative electrode current collector 10, and may include a solid electrolyte having lithium ion conductivity.

The solid electrolyte may include at least one selected from the group consisting of an oxide-based solid electrolyte, a sulfide-based solid electrolyte, a polymer electrolyte, and combinations thereof. Preferably, a sulfide-based solid electrolyte having high lithium ion conductivity is used. The sulfide-based solid electrolyte is not particularly limited. Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one of Ge, Zn, and Ga), Li₂S—GeS₂, Li₂S—SiS₂—Li₃PO₄, Li₂S—SiS₂-LiₓMO_{y} (where x and y are each independently a positive integer, and M is one of P, Si, Ge, B, Al, Ga, and In), Li₁₀GeP₂S₁₂, and the like.

Examples of the oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), and the like.

Examples of the polymer electrolyte may include a gel polymer electrolyte, a solid polymer electrolyte, and the like.

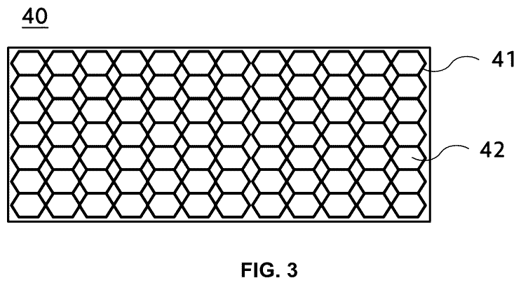

FIG. 3 shows a positive electrode layer 40 according to an embodiment of the present disclosure. The positive electrode layer 40 may include a sheet layer 41 with a network structure in which carbon nanotubes are arranged to provide pores, and a positive electrode material 42 filling the pores.

Typically, a positive electrode active material layer of an all-solid-state battery includes a positive electrode active material, a solid electrolyte, and a conductive additive. The conductive additive may be in a powder form, such as carbon black. In the related art, all-solid-state batteries are charged and discharged at high temperatures. As a result, the electrical conductivity of the positive electrode active material layer is sufficient even when the conductive-powder additive is used. However, when the existing all-solid-state battery is discharged at room temperature, the electrical conductivity of the positive electrode active material layer decreases, thereby reducing the efficiency of the battery. In addition, residual lithium is generated in the positive electrode active material layer, thereby reducing the capacity of the battery. Furthermore, when the conductive-powder additive is used, side reactions may occur between the conductive additive and the solid electrolyte, resulting in an increase in the internal resistance of the battery

In order to solve the above problem, the present disclosure is characterized in that the sheet layer 41 having the network structure and including the carbon nanotubes that are arranged to provide pores may be used instead of the conductive additive.

Unlike the conductive-powder additive, the sheet layer 41 does not aggregate or severely reduce electrical conductivity at room temperature. As a result, the all-solid-state battery 100 can have sufficient capacity and lifespan even when being charged and discharged at room temperature in a range of about ° C. to 25° C.

The sheet layer 41 may include a self-standing thin film formed by the entangled carbon nanotubes. The term “self-standing” of the sheet layer 41 may mean that the sheet layer 41 can maintain a form and a structure thereof regardless of the presence of other components.

The sheet layer 41 may include an oxygen-containing functional group on a surface thereof. The oxygen-containing functional group may include at least one selected from the group consisting of a ketone group (—C═O), a carboxyl group (—COOH), a hydroxyl group (—OH), and combinations thereof.

In addition, the sheet layer 41 may be heat-treated. The heat treatment may be performed to remove impurities such as amorphous carbon remaining in the sheet layer 41.

Through substitution and/or heat treatment of the oxygen-containing functional groups of the sheet layer 41, defects may be artificially created in the internal space of the sheet layer 41 to make many pores having large sizes. As a result, the positive electrode material 42 may easily fill the pores. In addition, by removing the impurities such as a catalyst and amorphous carbon in the sheet layer 41, side reactions may be prevented from occurring.

The sheet layer 41 may have a porosity in a range of about 60% to 80%. When the sheet layer 41 has a porosity of less than about 60%, the positive electrode material 42 may insufficiently fill the pores. In addition, when the sheet layer 41 has a porosity of greater than about 80%, the durability of the sheet layer 41 may decrease, and thus handling thereof may be difficult.

The sheet layer 41 may have a specific surface area in a range of about 200 m²/g to 1,000 m²/g. When the specific surface area of the sheet layer 41 satisfies the above range, the contact surface area between the sheet layer 41 and the positive electrode material 42 may be widened, so that charge and discharge reactions may easily occur.

The sheet layer 41 may have a thickness in a range of about 10 μm to 200 μm. When the thickness of the sheet layer 41 satisfies the above range, the efficiency of the battery and energy density per volume may be improved with balance. The sheet layer 41 may be a monolayer structure having the above thickness, or a multilayer structure having the total thickness of each layer within the above range. The number of layers in the multilayer is not particularly limited and may be two, three, or four layers.

The positive electrode material 42 may include a positive electrode active material and a solid electrolyte.

The positive electrode active material is configured to reversibly store and release lithium ions. The positive electrode active material may include an oxide active material or a sulfide active material.

The oxide active material may include a rock-salt-layer-type active material, such as LiCoO₂, LiMnO₂, LiNiO₂, LiVO₂, Li₁₊ₓNi_{1/3}Co_{1/3}Mn_{1/3}O₂, etc., a spinel-type active material, such as LiMn₂O₄, Li(Ni_{0.5}Mn_{1.5})O₄, etc., an inversed-spinel-type active material, such as LiNiVO₄, LiCoVO₄, etc., an olivine-type active material, such as LiFePO₄, LiMnPO₄, LiCoPO₄, LiNiPO₄, etc., a silicon-containing active material, such as Li₂FeSiO₄, Li₂MnSiO₄, etc., a rock-salt-layer-type active material in which a part of transition metal is substituted with dissimilar metal, such as LiNi_{0.8}Co_{(0.2-x)}AlₓO₂(0<x<0.2), a spinel-type active material in which a part of transition metal is substituted with dissimilar metal, such as Li₁₊ₓMn_{2-x-y}M_{y}O₄ (M is at least one of Al, Mg, Co, Fe, Ni, and Zn, and 0<x+y<2), and a lithium titanate, such as Li₄Ti₅O₁₂ and the like.

Examples of the sulfide active material may include a copper Chevrel, an iron sulfide, a cobalt sulfide, a nickel sulfide, and the like.

The solid electrolyte may include an oxide solid electrolyte or a sulfide solid electrolyte. However, preferably, a sulfide-based solid electrolyte having a high lithium ion conductivity is used. The sulfide-based solid electrolyte is not particularly limited. Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—Si S₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one of Ge, Zn, and Ga), Li₂S—GeS₂, Li₂S—SiS₂—Li₃PO₄, Li₂S—SiS₂-LiₓMO_{y} (where x and y are each independently a positive integer, and M is one of P, Si, Ge, B, Al, Ga, and In), Li₁₀GeP₂S₁₂, or the like.

The positive electrode material 42 may not include a binder. Since the sheet layer 41 supports the positive electrode material 42, there is no problem in the durability of the positive electrode layer 40 even when the binder is not used. However, the positive electrode material 42 may selectively include the binder according to desired specifications of the positive electrode layer 40, including thickness and surface area.

The binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The positive electrode layer 40 may include an amount of about 0.5% to 5% by weight of the sheet layer 41, an amount of about 75% to 90% by weight of the positive electrode active material, and an amount of about 5% to 20% by weight of the solid electrolyte, based on the total weight of the positive electrode layer. When the content of the sheet layer 41 is greater than about 5% by weight, the amount of the positive electrode material 42 may be relatively reduced, and thus the capacity of the battery may be reduced.

The positive electrode current collector 50 may include an electrically conductive plate-shaped substrate. The positive electrode current collector 50 may include an aluminum foil.

A method of manufacturing an all-solid-state battery may include preparing a thin film having a network structure and including carbon nanotubes that are arranged in the network structure to provide pores, obtaining a sheet layer 41 by performing at least one of acid treatment and heat treatment on the thin film, obtaining a positive electrode layer 40 by filling the pores of the sheet layer 41 with a positive electrode material 42, and obtaining an all-solid-state battery 100 which is a laminate of a negative electrode current collector 10, an intermediate layer 20, a solid electrolyte layer 30, the positive electrode layer 40, and a positive electrode current collector 50.

The acid treatment may be performed by immersing the thin film in an acid solution. The acid solution is not particularly limited, and may include hydrochloric acid (HCl), nitric acid (HNO₃), sulfuric acid (H₂SO₄), and the like. The acid solution is not particularly limited in concentration, and may have a concentration of about 10% by volume or less or about 5% by volume or less. By performing the acid treatment on the thin film, impurities such as a catalyst used during the preparation of the thin film can be removed. In addition, through the acid treatment, a surface of the sheet layer 41 may be substituted with oxygen-containing functional groups.

The heat treatment may be performed by heating the thin film to a temperature range of about 300° C. to 500° C. for a period of about 10 minutes to 2 hours in an atmospheric atmosphere. By performing the heat treatment on the thin film, impurities such as amorphous carbon and carbon particles remaining in the thin film can be removed.

The process of filling the sheet layer 41 with the positive electrode material 42 is not particularly limited. For example, the positive electrode material 42 may be added to a solvent to make a slurry, and the slurry may be blade-coated on the sheet layer 41 to fill the pores of the sheet layer 41 with the positive electrode material 42.

The all-solid-state battery 100 may be prepared by forming the laminate by stacking the negative electrode current collector 10, the intermediate layer 20, the solid electrolyte layer 30, the positive electrode layer 40, and the positive electrode current collector 50, is not particularly limited. Each component may be formed or provided at the same time or at different times. For example, in the manufacturing method, the all-solid-state battery 100 may be manufactured by forming the intermediate layer 20 on the negative electrode current collector 10, the solid electrolyte layer 30 on the intermediate layer 20, the positive electrode layer 40 on the solid electrolyte layer 30, and the positive electrode current collector 50 on the positive electrode layer 40 at once. Furthermore, the all-solid-state battery 100 may be manufactured by preparing each component separately and then stacking the components in the structure as illustrated in FIG. 1.

### Example

Hereinafter, the present disclosure will be described in more detail through specific examples. The following examples are only examples to help the understanding of the present disclosure, and the scope of the present disclosure is not limited thereto.

### Preparation Example

A self-standing thin film with a network structure in which carbon nanotubes were arranged to provide pores was prepared. The thin film was immersed in an aqueous solution of nitric acid (HNO₃) having a concentration of 10% by volume for about 10 minutes, and then washed. Next, the acid-treated thin film was heat-treated to a temperature of about 350° C. for about 30 minutes in an atmospheric atmosphere to obtain a sheet layer.

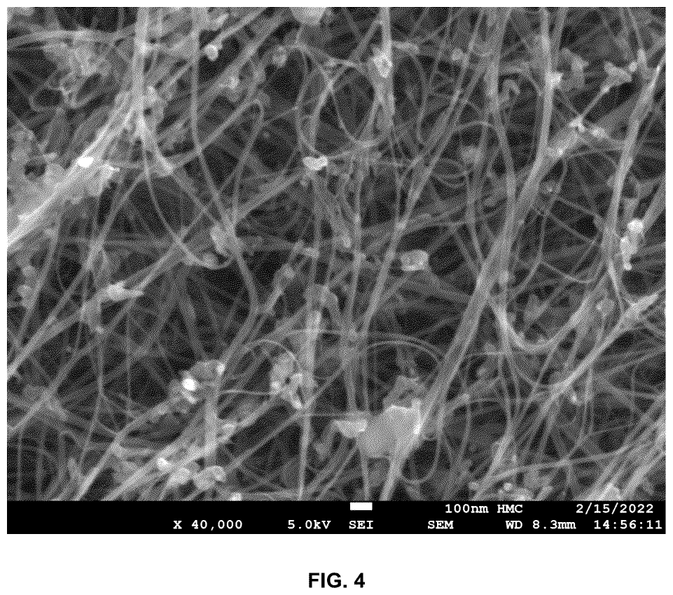

FIG. 4 shows a scanning electron microscope (SEM) analysis result for the sheet layer prepared according to Preparation Example. The sheet layer had a network structure in which carbon nanotubes were arranged to provide pores.

### Example

A positive electrode active material and a solid electrolyte were dry-mixed with a P/D mixer. A binder, a dispersant, and a solvent were added to the mixture and mixed with the P/D mixer to obtain a slurry.

The sheet layer obtained according to Preparation Example was placed on an aluminum foil serving as a positive electrode current collector. Then the slurry was applied onto the sheet layer and filled pores of the sheet layer with a blade to prepare a positive electrode layer. The positive electrode current collector and the positive electrode layer were dried at a temperature of about 90° C., and then dried in vacuo for about 4 hours at a temperature of about 140° C. The positive electrode layer included 80.8% by weight of the positive electrode active material, 16.6% by weight of the solid electrolyte, 0.5% by weight of the sheet layer, 2% by weight of the binder, and 0.1% by weight of the dispersant.

A solid electrolyte layer containing the sulfide-based solid electrolyte, an intermediate layer containing amorphous carbon and silver (Ag), and a negative electrode current collector were stacked on the positive electrode layer to obtain an all-solid-state battery.

### Comparative Example

The positive electrode active material and solid electrolyte according to Example were dry-mixed with a P/D mixer. A binder, a dispersant, a conductive additive, and a solvent were added to the mixture and mixed with the P/D mixer to obtain a slurry. Carbon black was used as the conductive additive.

A positive electrode layer was prepared by applying and drying the slurry on an aluminum foil serving as a positive electrode current collector. The positive electrode current collector and the positive electrode layer were dried to a temperature of about 90° C., and then dried in vacuo for about 4 hours at a temperature of about 140° C. The positive electrode layer included an amount of 80% by weight of the positive electrode active material, an amount of 16.4% by weight of the solid electrolyte, an amount of 1.5% by weight of the conductive additive, an amount of 2% by weight of the binder, and an amount of 0.1% by weight of the dispersant, based on the total weight of the positive electrode layer.

A solid electrolyte layer containing the sulfide-based solid electrolyte, an intermediate layer containing amorphous carbon and silver (Ag), and a negative electrode current collector were stacked on the positive electrode layer to obtain an all-solid-state battery.

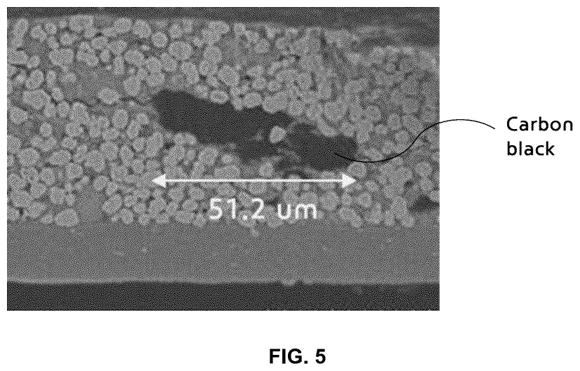

The all-solid-state battery obtained according to Comparative Example was charged and discharged at a temperature of about 25° C. FIG. 5 shows the scanning electron microscope (SEM) analysis result for a cross-section of a positive electrode layer prepared according to Comparative Example, the analysis being performed when the all-solid-state battery was in a discharged state. In Comparative Example, carbon black was used as the conductive additive. Carbon black aggregated in the intermediate layer due to low dispersibility.

The all-solid-state batteries, according to Example and Comparative Example, were each independently charged and discharged under the following conditions to evaluate capacity and capacity retention rate.
Charging conditions: at a voltage level of 4.25 V, a charging rate of 0.33 C, and a temperature of 50° C.
Discharging conditions: at a voltage level of 2.5 V, a discharging rate of 0.33 C, and a temperature of 50° C.

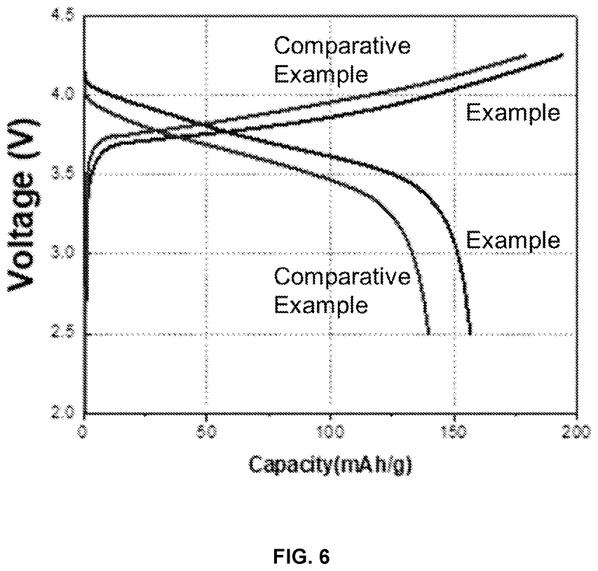

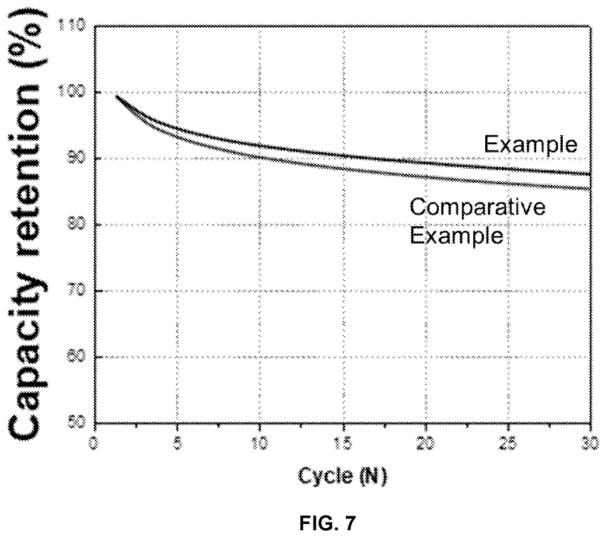

FIG. 6 shows a graph showing the results of measuring the capacity of the all-solid-state batteries of Example and Comparative Example. FIG. 7 shows a graph showing the results of measuring the capacity retention rate of the all-solid-state batteries of Example and Comparative Example. The all-solid-state battery of Example including the sheet layer had superior capacity and capacity retention rate to that of the Comparative Example.

While the present disclosure has been particularly shown and described with reference to exemplary embodiments thereof, it is to be understood that the scope of the present disclosure is not limited to the disclosed exemplary embodiments. Modified forms are also included within the scope of the present disclosure.

What is claimed is:

1. An all-solid-state battery comprising:
a negative electrode current collector;
an intermediate layer disposed on the negative electrode current collector and comprising a carbon material and a metal capable of alloying with lithium;
a solid electrolyte layer disposed on the intermediate layer;
a positive electrode layer disposed on the solid electrolyte layer; and
a positive electrode current collector disposed on the positive electrode layer,
wherein the positive electrode layer comprises a sheet layer having a network structure and including carbon nanotubes that are arranged in the network structure to provide pores; and a positive electrode material fills the pores.

2. The all-solid-state battery of claim 1, wherein the sheet layer comprises an oxygen-containing functional group on a surface thereof.

3. The all-solid-state battery of claim 2, wherein the oxygen-containing functional group comprises a ketone group (—C═O), a carboxyl group (—COOH), a hydroxyl group (—OH) or any combination thereof.

4. The all-solid-state battery of claim 1, wherein the sheet layer has a porosity in a range of about 60% to 80%.

5. The all-solid-state battery of claim 1, wherein the sheet layer has a specific surface area in a range of about 200 m²/g to 1,000 m²/g.

6. The all-solid-state battery of claim 1, wherein the sheet layer has a thickness in a range of about 10 μm to 200 μm.

7. The all-solid-state battery of claim 1, wherein the positive electrode material comprises a positive electrode active material and a solid electrolyte.

8. The all-solid-state battery of claim 7, wherein the positive electrode layer comprises:
an amount of about 0.5% to 5% by weight of the sheet layer;
an amount of about 75% to 90% by weight of the positive electrode active material; and
an amount of about 5% to 20% by weight of the solid electrolyte,
based on the total weight of the positive electrode layer.

9. The all-solid-state battery of claim 1, wherein the carbon material comprises amorphous carbon, and
the metal comprises gold (Au), platinum (Pt), palladium (Pd), silicon (Si), silver (Ag), aluminum (Al), bismuth (Bi), tin (Sn), zinc (Zn), or any combination thereof.

10. The all-solid-state battery of claim 1, wherein the battery is operable in a temperature range of about 15° C. to 25° C.

11. A method of manufacturing an all-solid-state battery, comprising:
preparing a thin film having a network structure and comprising carbon nanotubes that are arranged to provide pores;
preparing a sheet layer by performing acid treatment, heat treatment, or combinations thereof on the thin film;
preparing a positive electrode layer by filling the pores of the sheet layer with a positive electrode material; and
preparing an all-solid-state battery comprising a laminate formed by stacking a negative electrode current collector, an intermediate layer comprising a carbon material and a metal capable of alloying with lithium, a solid electrolyte layer, the positive electrode layer, and a positive electrode current collector.

12. The method of claim 11, wherein the acid treatment is performed by immersing the self-standing thin film in an acid solution, and
the sheet layer comprises an oxygen-containing functional group on a surface thereof, and
the oxygen-containing functional group comprises a ketone group (—C═O), a carboxyl group (—COOH), a hydroxyl group (—OH), or any combination thereof.

13. The method of claim 11, wherein the heat treatment is performed by heating the thin film to a temperature range of about 300° C. to 500° C. for a period of about 10 minutes to 2 hours in an atmospheric atmosphere.

14. The method of claim 11, wherein the sheet layer has a porosity in a range of about 60% to 80%.

15. The method of claim 11, wherein the sheet layer has a specific surface area in a range of about 200 m²/g to 1,000 m²/g.

16. The method of claim 11, wherein the sheet layer has a thickness in a range of about 10 μm to 200 μm.

17. The method of claim 11, wherein the positive electrode material fills the pores of the sheet layer by applying a slurry comprising the positive electrode material on the sheet layer.

18. The method of claim 11, wherein the positive electrode material comprises a positive electrode active material and a solid electrolyte.

19. The method of claim 18, wherein the positive electrode layer comprises:
an amount of about 0.5% to 5% by weight of the sheet layer;
an amount of about 75% to 90% by weight of the positive electrode active material; and
an amount of about 5% to 20% by weight of the solid electrolyte,
based on the total weight of the positive electrode layer.

20. The method of claim 11, wherein the carbon material comprises amorphous carbon, and
the metal comprises gold (Au), platinum (Pt), palladium (Pd), silicon (Si), silver (Ag), aluminum (Al), bismuth (Bi), tin (Sn), zinc (Zn), or any combination thereof.
